(19) United States
(12) Patent Application Publication
(10) Pub. No.: US 2024/0239230 A1
(43) Pub. Date: Jul. 18, 2024

(54) SYSTEM FOR A DEMAND-SENSITIVE NETWORKED FLEET OF MOBILE POWER DISPENSING STATIONS

(71) Applicant: Power Hero Corp., La Verne, CA (US)

(72) Inventor: Esmond Goei, La Verne, CA (US)

(21) Appl. No.: 18/392,443

(22) Filed: Dec. 21, 2023

Related U.S. Application Data
(60) Provisional application No. 63/439,370, filed on Jan. 17, 2023.

(51) Int. Cl. B60L 53/68; B60L 53/57; B60L 53/62; B60L 53/66; B60L 53/67; G06Q 30/08; G07C 5/00; G07C 5/02; H02J 1/08

(52) U.S. Cl. CPC B60L 53/68; B60L 53/57; B60L 53/62; B60L 53/665; B60L 53/67; G06Q 30/08; G07C 5/008; G07C 5/02; H02J 1/084

(57) ABSTRACT

A system for networking a plurality of electric vehicle charging networks includes a central charger controller for controlling access to a plurality of charging devices associated with the plurality of electric vehicle charging networks. A plurality of control nodes each associated with one of the plurality of electric vehicle charging networks enables communication between the central charger controller and each of the plurality of electric vehicle charging networks. A plurality of application program interfaces each associated with one of the plurality of control nodes enables communication between a control node and one of the plurality of electric vehicle charging networks. The central charger controller receives a request for charging from an electric vehicle associated with a first electric vehicle charging network of the plurality of electric vehicle charging networks and establishes a charging event for the first vehicle in a second electric vehicle charging network of the plurality of electric vehicle charging networks.

### CROSS-REFERENCE TO RELATED APPLICATIONS

This application claims the benefit of U.S. Provisional Application No. 63/439,370, filed on Jan. 17, 2023, entitled A SYSTEM FOR A DEMAND-SENSITIVE NETWORKED FLEET OF MOBILE POWER DISPENSING STATIONS (Atty. Dkt. No. IJUZ60-35694), the specification of which is incorporated by reference herein in their entirety.

### TECHNICAL FIELD

The present invention relates to electric vehicle charging networks, and more particularly to a system for controlling operation of multiple, unrelated electric vehicle charging networks through a central controller.

### BACKGROUND

The current cost of constructing and commissioning a high-power dispensing station such as a Direct Current Fast Charging (“DCFC”) Level 3 Electric Vehicle (“EV”) charging station with four to six charging stalls (or ports) is presently averaging in the hundreds of thousands of dollars and takes between several weeks to 24 months from initial planning to commissioning. The same is true in the case of Level 2 EV charging station to a lesser economic extent and time. This makes electric vehicle charging station implementation a very high cost and a time-consuming endeavor. Several problems and issues arise relating to charging electric vehicles (EVs) at geographically fixed charging stations as more fully described below.

As population patterns in density, distribution and economic status change, the fixed placement of DCFC stations may become incongruent with the needs of the communities and EV owners or drivers that accompany the change in population patterns. For example, station sites may become more congested and cause local traffic issues that discourages station visitations. Such incongruences could result in reduced usage of installed stations which is a costly and wasted use of property, equipment, and labor and may eventually lead to the withdrawal of services which would negatively impact the EV drivers in such communities.

As EV technology evolves, frequency and patterns of EV charging may also change, thereby potentially disfavoring public fixed DCFC and Level 2 stations. For example, the communities in and around the particular stations may be incentivized through government subsidies to install Level 2 chargers in their home garages which will consequently and likely reduce visitations to affected DCFC and Level 2 stations.

As competing EV charging companies emplace new fixed charging stations to accommodate evolving population dynamics, some EV charging companies may find that their existing fixed stations are rendered less convenient to drive to and thus suffer revenue declines.

Construction and/or road closures may affect the economic viability of some or all the fixed charging stations of an EV charging company which would then require moving the stations to new sites at great costs, or even outright abandonment of such stations.

Community power disruptions and vandalism may also reduce the operating effectiveness of fixed charging stations thereby rendering such affected charging stations to experience drop-off in utilization and revenue.

EV standards continue to evolve and are subject to change and charging stations must also change with the underlying growth and technology evolution of the EVs that need charging. For example, onboard EV batteries may be capable of faster charging, or fixed chargers may be configured to charge multiple EVs simultaneously. However, if the existing station site is too small to cope with increased usage and faster throughputs, then local traffic may be impacted and cause EV owners to avoid using the affected stations thereby affecting the operating economics of the fixed stations.

Demand may also change due to climate changes, and drastic weather conditions resulting from tornados, earthquakes and other natural hazards that lead to closure of communities around the station and/or destruction of the fixed station itself.

The above noted problems may be overcome by the use of mobile DCFCs and Level 2 chargers that should require a less intensive capital outlay in order to implement the mobile DCFC and Level 2 charging stations.

### SUMMARY

The present invention, as disclosed and described herein, in one aspect thereof comprises a system for networking a plurality of electric vehicle charging networks and includes a central charger controller for controlling access to a plurality of charging devices associated with the plurality of electric vehicle charging networks. A plurality of control nodes each associated with one of the plurality of electric vehicle charging networks enables communication between the central charger controller and each of the plurality of electric vehicle charging devices. A plurality of application program interfaces each associated with one of the plurality of control nodes enables communication between a control node and one of the plurality of electric vehicle charging networks and thereon to the plurality of charging devices. The central charger controller receives a request for charging from an electric vehicle associated with a first electric vehicle charging network of the plurality of electric vehicle charging networks and schedules a charging event for the first vehicle in the same electric vehicle charging network or a second electric vehicle charging network of the plurality of electric vehicle charging networks.

### BRIEF DESCRIPTION OF THE DRAWINGS

For a more complete understanding, reference is now made to the following description taken in conjunction with the accompanying Drawings in which:

FIG. 1 illustrates a system for providing centralized control of multiple electric vehicle charging networks;

FIG. 2 illustrates further details of the system for providing centralized control of multiple electric vehicle charging networks in conjunction with an artificial intelligence (AI) system;

FIG. 3 illustrates various functionalities of a multi-EV charger network controller;

FIG. 4 illustrates a block diagram of a mobile charging station;

FIG. 5 illustrates a flow diagram of the process for dispatching a mobile charging station;

FIG. 6 illustrates a block diagram of the structures for enabling communications between the multi-EV charger network controller and a subscriber app within a local EV charging network;

FIG. 7 illustrates an autonomous vehicle transport platform with associated mobile charging carts; and

FIG. 8 illustrates a flow diagram of the process for dispatching or reserving an EV charger among multiple, associated EV charger networks.

### DETAILED DESCRIPTION

Referring now to the drawings, wherein like reference numbers are used herein to designate like elements throughout, the various views and embodiments of a system for a demand sensitive networked fleet of mobile power dispensing stations are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

The use of mobile Direct Current Fast Charging (“DCFC”) or Level 2 charging, collectively overcomes many of the above-described problems. Deployment of mobile charging stations is more cost effective than fixed charging stations as there is no requirement to acquire land on which to construct the station. Thus, mobile stations can be commissioned quickly which results in shorter “construction” time, quicker time to revenue generation, and likely less troublesome in getting operating permits, etc. A mobile charging station can be moved and deployed where it is needed thereby enabling capturing revenue that may otherwise be lost. Mobile charging stations can be equipped with renewable energy generators that use the sun or wind for recharging the station's onboard batteries that are used to charge electric vehicles (“EVs”) that the station services. Due to the mobile nature of the station, a mobile charging station can orient its position relative to the wind or sun direction to maximize power generation by taking advantage of changing wind patterns and solar strength whereas a fixed station would have to deploy more complex mechanisms for wind/sun tracking. The responding mobile charging platform or station could also be a hydrogen powered (or methane, natural gas, propane, or even gasoline powered etc.) vehicle with the built in capability of producing electricity onboard and to use such electricity to charge another vehicle or device. Mobile stations have the option to charge its onboard batteries at multiple regeneration sites/sources that is most appropriate at the time. Fixed stations are dependent on the localized circumstances that prevail so if there is a utility power failure at the station's site for whatever reason then the station would be unable to provide charging to EVs.

For ease of understanding illustration, the system described herein is that of an EV charging implementation for charging EV's. However, it should be clear to one skilled in the art that the use of electric chargers to charge electric vehicles are merely one example and that the system is equally applicable to a variety of power medium and power dispensing equipment and stations, such as hydrogen, methane, natural gas, propane, etc. as an energy medium.

This system may be implemented in system such as those shown in U.S. Pat. No. 10,960,782, filed Feb. 19, 2019, entitled METHOD AND DEVICE FOR CONVERTING STANDALONE EV CHARGING STATIONS INTO INTELLIGENT STATIONS WITH REMOTE COMMUNICATIONS CONNECTIVITY AND CONTROL (Atty. Dkt. No. IJUZ60-34488), U.S. Pat. No. 10,857,902, filed Apr. 3, 2017, entitled AUTOMATED SYSTEM FOR MANAGING AND PROVIDING A NETWORK OF CHARGING STATIONS (Atty. Dkt. No. IJUZ60-33491). This application also claims benefit to U.S. patent application Ser. No. 17/203,278, filed Mar. 16, 2021, entitled METHOD AND DEVICE FOR CONVERTING STANDALONE EV CHARGING STATIONS INTO INTELLIGENT STATIONS WITH REMOTE COMMUNICATIONS CONNECTIVITY AND CONTROL (Atty. Dkt. No IJUZ60-35191). U.S. patent application Ser. No. 16/412,118, filed May 14, 2019, entitled MOBILE ELECTRIC VEHICLE CHARGING STATION SYSTEM (Atty. Dkt. No. IJUZ60-34614), U.S. patent application Ser. No. 17/104,123, filed Nov. 25, 2020, entitled A UNIVERSAL AUTOMATED SYSTEM FOR IDENTIFYING, REGISTERING AND VERIFYING THE EXISTENCE, LOCATION AND CHARACTERISTICS OF ELECTRIC AND OTHER POWER OUTLETS BY RANDOM USERS AND FOR RETRIEVAL AND UTILIZATION OF SUCH PARAMETRIC DATA AND OUTLETS BY ALL USERS (Atty. Dkt. No. IJUZ60-35047), U.S. patent application Ser. No. 17/105,485, filed Nov. 25, 2020, entitled AUTOMATED SYSTEM FOR MANAGING AND PROVIDING A NETWORK OF CHARGING STATIONS (Atty. Dkt. No. IJUZ60-35026), U.S. patent application Ser. No. 17/533,706, filed Nov. 23, 2021, entitled METHODS AND DEVICES FOR WIRELESS AND LOCAL CONTROL OF THE TWO-WAY FLOW OF ELECTRICAL POWER BETWEEN ELECTRIC VEHICLES, BETWEEN EVS AND ELECTRICAL VEHICLE SUPPLY EQUIPMENT(S), AND BETWEEN THE EVSE(S) AND THE ELECTRICITY GRID (Atty. Dkt. No IJUZ60-35397) and U.S. patent application Ser. No. 17/538,706, entitled METHODS AND DEVICES FOR WIRELESS AND LOCAL CONTROL OF THE TWO-WAY FLOW OF ELECTRICAL POWER BETWEEN ELECTRIC VEHICLES, BETWEEN EVS AND ELECTRICAL VEHICLE SUPPLY EQUIPMENT(S), AND BETWEEN THE EVSE(S) AND THE ELECTRICITY GRID (Atty. Dkt. No. IJUZ60-35405) each of which are incorporated herein by reference in their entirety.

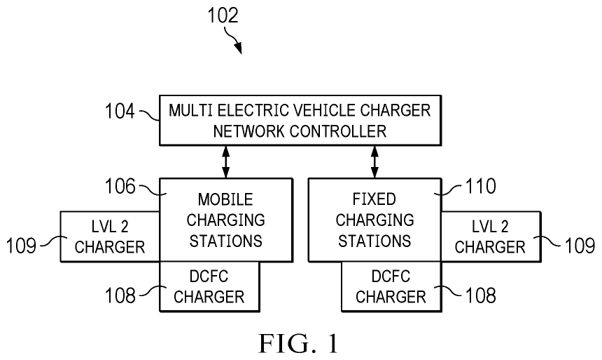

Referring now to the drawings, and more particularly to FIG. 1, there is illustrated the use of a system 102 for providing centralized control of multiple electric vehicle charging networks. Using artificial intelligence technologies (AI) and advanced network communications technologies or programmed processing devices as system controllers, such centralized control may be implemented virtually in that “centralized control” may be delegated to a specific EV charging network controller across the overall system of a plurality of interconnected EV charging networks. Such a delegation of control could be scheduled or triggered in instances of disruption of the power grid in one or more EV charging network thereby enabling a mechanism for continuing service under adverse circumstances. The system 102 includes a multi-electric vehicle charger network controller 104 comprising a server or processor that communicates with a plurality of mobile charging stations 106 each having a charger 108 associated therewith. In addition to being connected to multiple mobile charging stations 106 the multi-electric vehicle charger network controller 104 may be connected to multiple fixed charging stations 110, or a hybrid network comprising of both mobile and fixed charging stations. The charger 108 may also be the electric vehicle itself that responds to the request for mobile charging as such electric vehicles are already being produced with charging capabilities, but they lack the service network that is described herein in which to offer such charging service. The overall system 102 comprises associated electric vehicle charging networks of both mobile charging stations and fixed charging stations. The multi-electric vehicle charger network controller 104 is sensitive to the daily and intraday charging demands of EV drivers and their EVs. The controller 104 monitors the states of fleets of mobile electric vehicle charging stations 106 (“MStations”) and fixed local stations 110 of one or more electric vehicle charging networks. The controller 104 dispatches available mobile electric vehicle charging stations 106 to rendezvous with a requesting EV driver at appropriate location coordinates for charging their electric vehicle. Alternatively, as the circumstances dictate, the controller 104 may direct the electric vehicle driver to a fixed location 110. Each mobile charging station 106 contains one or more DCFC EV chargers 108 that can charge an EV to at least 80% charge in less than 30 minutes and/or one or more Level 2 chargers 109. MStations 106 use either autonomous vehicles or manually operated vehicles as the transport mechanism or mobile platform for the chargers 108 or 109 that are mounted or embedded on the mobile platform 106. As mentioned earlier, an MStation may also utilize the power source of the mobile platform itself to generate the charging electricity that is administered to the EV of the requesting EV driver.

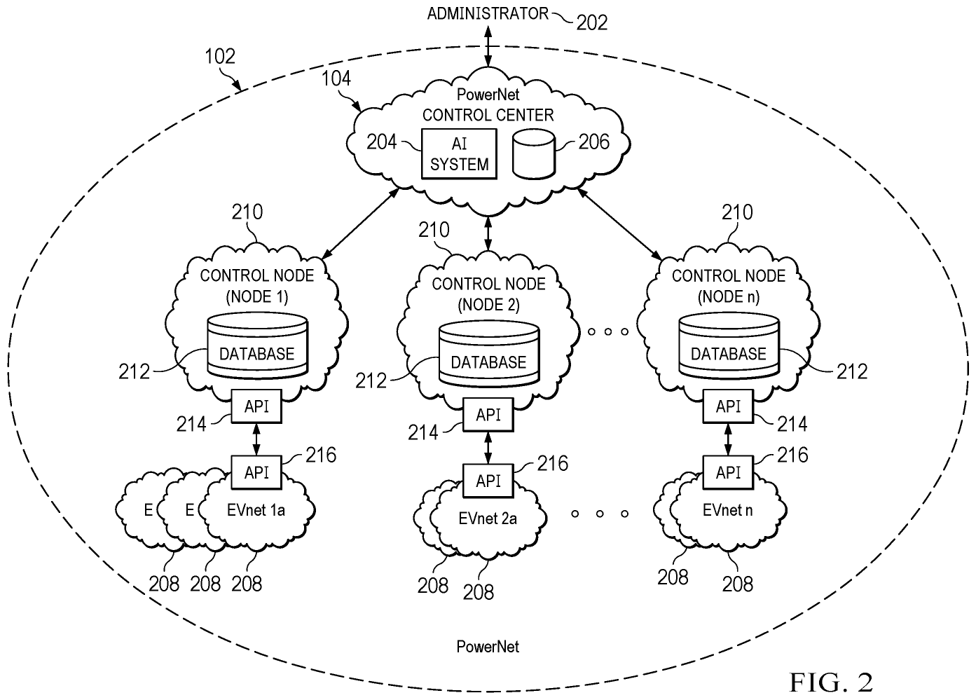

Referring now to FIG. 2, there is more particularly illustrated the system 102 for providing centralized control of multiple electric vehicle charging networks. The system 102 includes the multi-EV charger network controller 104 that may be under the control of a system administrator 202 or an associated AI system 204. The multisystem charger controller 104 makes decisions based upon information stored within an associated database 206 that stores information related to currently monitored electric vehicles and associated EV charging networks 208.

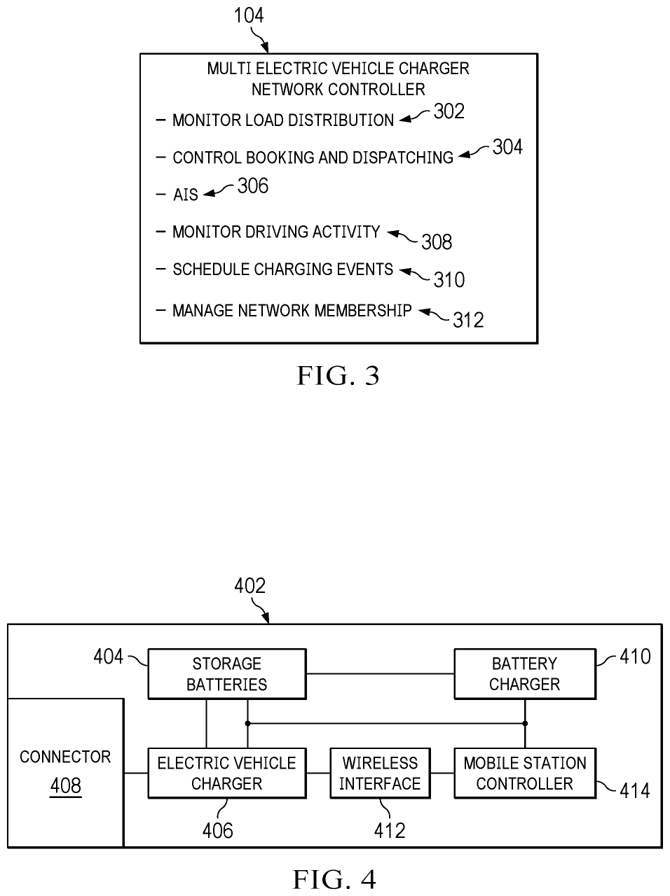

Referring now also to FIG. 3, the multi-EV charger network controller 104 performs a number of functionalities with respect to the aggregation and interoperability of multiple electric vehicle charging networks 208. The multi-EV charger network controller 104 provides numerous functionalities such as monitor load distribution 302, control booking and dispatching 304, artificial intelligence system 306, monitor driving activity 308, schedule charging events 310 and manage network membership 312. The monitor load distribution functionality 302 enables the monitoring of charger demands within a particular geographic area based upon the number of electric vehicles in an area which may soon require charging services. The control booking and dispatching functionalities 304 controls the booking of fixed charging stations 110 and the dispatching of mobile charging stations 106 to locations for use by EVs. The artificial intelligence system 306 provides AI functionalities enabling the system to autonomously control various processes of the multi-EV charger network controller 104. The monitor driving activity functionality 308 monitors the driving actions of a particular EV in order to assist in determining when charging may be necessary for the associated EV. The schedule charging events functionality 310 enables automatic scheduling of a charging session with an electric vehicle based upon the system's determination that the EV will run low on electric power at a particular point in time. The manage network membership functionality 312 provides for control of new member charging networks 208 and charging providers joining the multi-EV charger network 102 and controlling all of the charging devices associated with the new charger network member and the subscribers associated with the new network member. Any new charging provider of a member network 208 must be validated as a genuine provider with the necessary equipment or power generating capability (e.g. an onboard power generator [regardless of mechanism employed in producing the power, such solar, gasoline powered generator, etc.]). Also, providers that fail to live up to their claim to be a charging station provider of power or other service will be censored and/or penalized for false advertising or failing to provide the advertised service.

Referring now back to FIG. 2, the multi-EV charger network controller 104 communicates with each of the associated electric vehicle charger networks 208 through an associated control node 210. Each control node 210 is associated with one or more electric vehicle charging networks 208 that a system user may access in order to provide for charging of their electric vehicle. The control node 210 includes a database 212 that stores information relating to the various electric vehicle charger networks 208 that are associated therewith and the electric vehicle users that are associated with the networks 208.

The control node 210 has associated therewith an application program interface (API) 214. The API 214 enables communications with each of the electric vehicle charger networks 208 through an API 216 that is uniquely associated with each of the electric vehicle charger networks 208. Utilizing the APIs 214/216, the control nodes 210 may communicate with each of the electric vehicle charger networks 208 and provide communications to the multi-electric vehicle charger network controller 104.

The multi-electric vehicle charger network controller 104 oversees and coordinates the operation of each of the several independent EV charging networks 208. The charging stations 106 and 110 associated with each of the electric vehicle charging networks 208 and their respective chargers 108 and 109 may be utilized by users that are subscribers to any of the plurality of electric vehicle charging network members 208 that are under the control of the multi-EV charger network controller 104. The operation of the multi-EV charger network controller 104 is managed organizationally by an entity often called a “consortium.” Each electric vehicle charger network 208 operates its own set of mobile charging stations 106 and fixed charging stations 110 which are not illustrated in FIG. 2. Each electric vehicle charging network 208 operates a variety of electric vehicle chargers (“EVSE”) that are of different power grades and design standards such as Level II, Level III as well as a variety of different charging connectors and charging protocols such as SAE J1772 connector for Level 2 chargers, CHAdeMO and SAE Combo (also called CCS for “Combo Charging System”) and NACS (“North American Charging Standard” which is a standard used by Tesla Inc.) connectors for Level 3 EVSEs.

The collections of mobile charging stations 106 of each EV charging network 208 and in aggregate the mobile charging stations 106 in all of the EV charging networks 208 is referred to as a “fleet” of chargers but could also refer to the fleet of a specific electric vehicle charger network 208. The operation of each electric vehicle charger network 208 and the state of each electric vehicle charger network's charger 108 or 109 whether fixed or mobile is coordinated between electric vehicle charger networks. Each electric vehicle charger network 208 manages and tracks the status of its own fixed stations 110, mobile charging stations 106 and on board EVSEs. This information is regularly communicated to the multi-electric vehicle charger controller 104 through the control node 210 associated with the network 208. The multi-EV charger network controller 104 monitors and manages the inner operations and inner communications between the independent electric vehicle charging networks 208. All charging stations whether fixed 110 or mobile 106 and their respective EVSEs are assigned a unique identifier. Using the unique identifier, the operating status of the charging stations may be shared with all electric vehicle charging networks 208 associated with the system 102.

The independent electric vehicle chargers 208 are managed as a group of networks whereby Group 1 comprise network 1A, network 1B and so forth to network In. Similarly, for the second group of electric vehicle chargers 208, designation of networks in that group are network 2A, network 2B and so on to network 2n. Each group or cluster of electric vehicle charging networks 208 are managed and monitored by the central node 210 which are designated node 1 and node 2 in FIG. 2. Each Node 210 is managed by the multi-electric vehicle charger network controller 104. This topology enhances control and data transmission and other considerations, but other network topologies may also be utilized. FIG. 2 illustrates three separate control nodes 210. However, it will be realized that any number of control nodes 210 may be used to encompass a variety of different electric vehicle charging networks 208. Each electric vehicle charging network 208 manages a variety of mobile charging stations 106, and fixed charging stations 110 which are not illustrated in FIG. 2.

Referring now to FIG. 4, there is illustrated a block diagram of a mobile charging station 402. The mobile charging station 402 includes storage batteries 404 for storing charge to charge a connected electric vehicle. The storage batteries 404 connected with an electric vehicle charger EVSE (“Electric Vehicle Supply Equipment”) 406 provides a charging current to a connected electric vehicle through a connector 408 responsive to the charge current provided by the storage batteries 404. The storage batteries 404 may be recharged using a battery charger 410 for charging the storage batteries 404. Communications with the electric vehicle mobile charging station 402 may be carried out via a wireless interface 412. The electric vehicle charger 406 is controlled via the mobile station controller 414 that connects with each of the various system components. The storage batteries 404 may also be charged onboard the transport platform by the platform's own propulsion power source such as in the case of a hydrogen powered vehicle which converts hydrogen into electricity for mobility. The electricity that is hydrogen-generated may be used to charge the onboard storage batteries 404.

Each electric vehicle mobile charging station 402 is equipped with storage batteries 404 and one or more electric vehicle chargers 406 that can provide the charging current to a variety of electric vehicles connected via the connector 408. The electric vehicle charger EVSEs 406 derives their power from the mobile charging stations 402 onboard storage battery modules 404. The onboard battery modules 404 may also be recharged using the battery charger 410 which may comprise an onboard fossil fuel powered generator, solar generator, wind generator or combination solar and wind generator. Alternatively, the electric vehicle mobile charging station 402 may utilize an exchangeable battery module system for the storage batteries 404. Such equipped mobile charging stations 402 once depleting their onboard storage battery power are regularly directed to automatically travel to a designated battery exchange depot to exchange their depleted battery modules for freshly charged battery modules. Electric vehicle mobile charging stations 402 that are equipped with permanent onboard battery modules will automatically travel to available designated recharging facilities when necessary to recharge their onboard battery modules.

Each electric vehicle mobile charging station 402 is wirelessly connected with the electric vehicle charging network 208 via the wireless interface 412 using the Internet or other communications medium or method. Each mobile electric vehicle charging station 402 reports the operating status of the EVSE charger 406 and mobile charging station to its associated network which is then forwarded to the multi-EV network charger controller 104 via the control nodes 210.

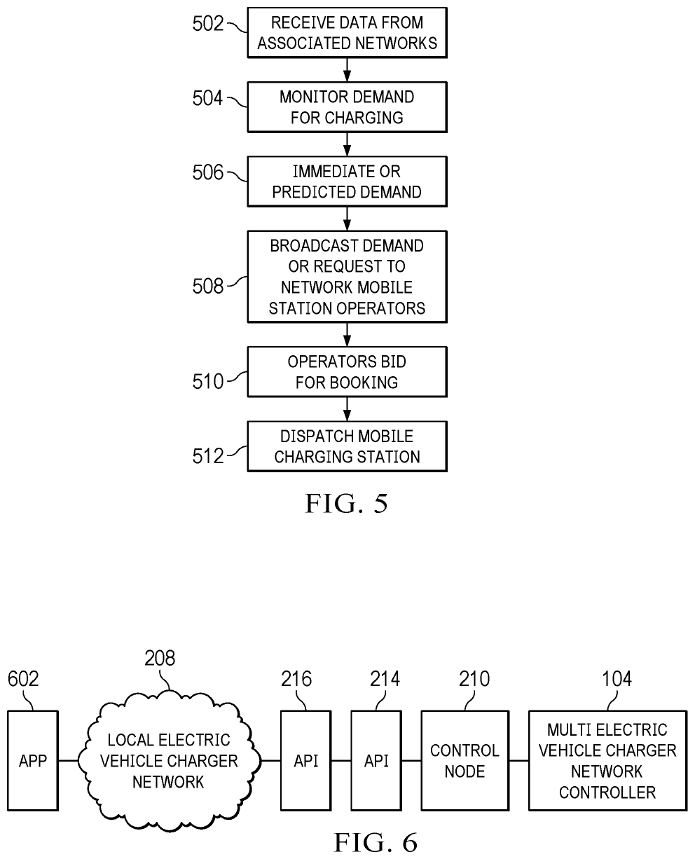

Referring now to FIG. 5, there is illustrated a flow diagram illustrating the manner in which the charging demand in a serviced area is monitored for a mobile charging network 208. The multi-EV charger network controller 104 receives data from each of the associated electric vehicle charging networks in 208 at step 502. This information is used by the controller 104 to monitor the charging demand distribution at step 504 of all of the EV charging networks 208 across the system's geographic territory. Based upon the monitored demand inquiry, step 506 determines if there is a need for immediate or predicted demand. In the event of an immediate or reserved demand initiated by an EV driver, such demand (request for service) is posted or broadcasted at step 508 to all active mobile station operators within a system-specified geography or protocol and any available mobile charger station operator that has the appropriate service capability can bid for the requested service request at step 510. Based upon system-established protocols the successful mobile charging station bidder is dispatched or scheduled at step 512 based upon the determined immediate or scheduled demand to the requested or appropriate location. In the case of a predicted demand in specific areas, such demand is also broadcasted to available mobile station operators so that they can opt to position themselves near the predicted demand area for service requests.

Each electric vehicle charging network 208 includes its own set of subscribers that are registered to use the mobile charging stations 106 and fixed charging stations 110 in its own charging network. Besides managing the use of charging stations within its own network, each electric vehicle charging network 208 also manages the communications with their subscribers through a software application as more particularly illustrated in FIG. 6. The app 602 is downloaded by subscribers into a communication device for reserving individual chargers at specific times. Devices on which the apps 602 may be downloaded include smart phones, tablets, smart watches or even desktop devices with Internet conductivity. The app 602 enables communications between the subscribers and the local EV charging network 208.

All electric vehicle charging networks 208 that joined the consortium agree to adhere to rules of engagement which include but are not limited to the standardization and synchronization of data collection, database configurations and access controls and communications protocol between electric vehicle charging networks via the respective application program interfaces 216. Communications from the local EV charging network 208 are provided from its application program interface 216 to the API 214 of the associated control node 210. The control node 210 may then provide communications on to the multi-EV charger network controller 104.

As shown in FIG. 6 subscribers activate their respective app 602 on their communications device to access the electric vehicle charger network 208 of which they are subscribers. The electric vehicle charger network 208 then automatically registers the users' activity, the users' location and alerts the multi-EV network controller 104 through the APIs 216/214 and control node 210. Such activity is indicative of potential bookings of charging stations in the users' areas so the multi-EV charger network controller 104 and all local EV charging networks 208 are on alert and track the demand for charging at the users' locations and corresponding areas. This information is utilized by the AI system 204 to predict demand for charging throughout the geography of the system. The app 602 can be designed to solicit users to input various data into the system such as their current EV battery charge level, their current odometer reading, planned destinations (which may be automatically collected as user's use their GPS or other navigational programs). The current state of electric vehicle designs already incorporates data recording and the ability to transmit such data for maintenance purposes. This data may be captured by the multi-EV charger network controller 104 if appropriately authorized and enabled.

With the advent of mobile electric vehicle charging stations 106, in addition to the ability to enable charging reservations of fixed stations, app 602 users may also request the electric vehicle charger network controller 104 to monitor a user's driving activity and enable the controller 104 to schedule charging events throughout the day provided that the user has enabled EV data access by the controller 104 directly with their electric vehicle, and/or provides the controller 104 with relevant data such as EV charger level and odometer readings throughout the day. The system 102 defines the specific data that is required to be captured by the respective charging networks 208 apps as may be required by the AIS 204. The multi-EV charger network controller 104 and the AIS 204 utilize the subscribers' activity data and the operating status data reported by the electric vehicle charging networks 208 to manage the dispatch of mobile charging stations 106 in correlation with the status of fixed charging stations 110 that may be idle as the controller 104 may also direct subscribers to fixed charging stations as may be appropriate.

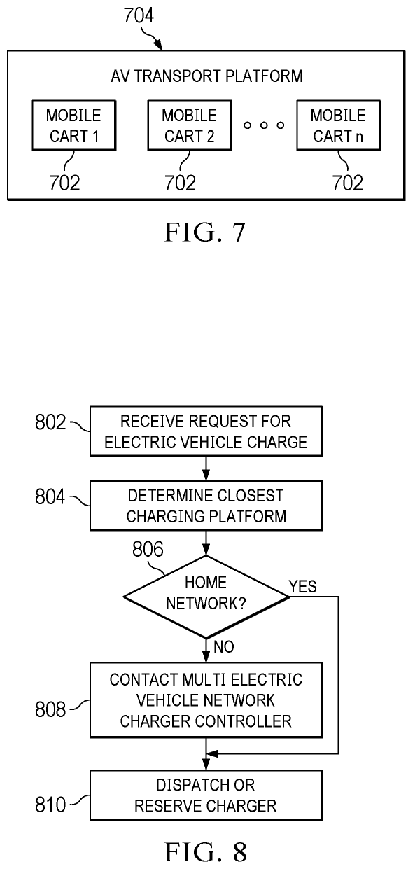

In addition to mobile charging stations 106 that can navigate public roads and highways, electric vehicle chargers 406 may be incorporated on short distance mobile carts 702 as illustrated in FIG. 7. The mobile carts 702 can be mounted on an autonomous vehicle transport platform 704 or be controlled manually by human operator either remotely or on-site. In such instances, the mobile carts 702 may be transported to specific satellite charging areas such as a university campus, a business park, a small community, etc. where the mobile carts 702 have a limited travel range. Delivery of the mobile carts 702 may be executed via various modes of transportation such as trucks, trains, etc. Mobile carts 702 of chargers that are associated with the multi-EV network charger controller 104 can be deployed across geographical boundaries and may be deployed in conjunction with mobile carts 702 of different electric vehicle charging networks 208 as demand patterns change throughout the day. As the onboard charge of the mobile carts 702 are depleted to a predetermined threshold, such mobile carts may be picked up and replaced by a freshly charged mobile cart. Like mobile charging stations 106 and their onboard electric vehicle chargers, each mobile cart's 702 location and operating status of each mobile cart charger is monitored by their associated electric vehicle charging network 208 and regularly reported to the multi-EV charger network controller 104.

Referring now to FIG. 8, there is illustrated a flow diagram of the process for dispatching or reserving a charger for an EV over multiple charging networks 208. The multi-EV charger network controller 104 enable subscribers of one charging network 208 to make reservations and use chargers on another charging network without being a subscriber of the latter charging network and vice versa. A subscriber to a charging network 208 can make reservations of and use chargers on a charging network to which they are not a subscriber. This internetwork functionality is enabled through the application programming interfaces 216 and 214 (FIG. 2) resident on correspondent charging networks 208 and the control nodes 210 to enable the software of one charging network 208 to communicate with another charging network. The multi-EV charger network controller 104 manages the membership and participation of multiple charging networks 208, in the internetwork protocols and APIs. In some cases, charging networks may only have one charging station or one charger. Any charger owner may be admitted to the multi-EV charger network consortium system 102 as long as its chargers and fixed and mobile stations conform to the consortium's communication and operations protocols that are required. The open access to the multi-EV charger network consortium system enables and encourages the development of numerous charging stations whether mobile or fixed as each member can provide extensive access to charging units throughout a geographical area managed by the multi-EV charger network controller 104 while distributing the financial burden of providing charging stations amongst many investors and owners.

As mobile charging stations 106 throughout the system geography are tracked throughout the day, the multi-EV charger network controller 104 can match network subscribers' EVs (with their desired charging locations) with the respective mobile chargers 106 that are closest and/or are more readily available as shown in FIG. 8. An electric vehicle charging network 208 receives a request for an electric vehicle charge at step 802. The EV charging network 208 contacts the multi-EV network charger controller 104 to determine a closest charging platform to the requesting EV at step 804. If the EV is determined to be within their home network at step 806 then the vehicle is dispatched to a local charger at step 810. However, if inquiry step 806 determines that the EV is not located within their home network the multi-EV charger network controller 104 is contacted at step 808 to determine a most closely located charger at step 808 from amongst the plurality of member charging networks 208. The multi-EV charger network controller 104 then either dispatches a mobile charger 106 to the requesting EV or reserves a charger at a fixed charging station 110 at step 810 to enable charging of the EV from the network 208 having the closet charger.

It is anticipated that mobile charging stations 106 that are members of the consortium system would be more efficiently utilized in comparison to the utilization of fixed stations that are unlikely to be used if their fixed position is not conveniently located to a particular electric vehicle's charging demand at a specific time. Such efficiency could result in reducing the number of fixed stations required as well as the amount of capital necessary for implementing such fixed stations. Also, the time required to construct and deploy a mobile charging station 106 will be less than the time to plan, obtain site permits, install powerlines, construct the station site and commission a fixed charging station 110. Thus, the above-described system provides a more efficient way of implementing a charging infrastructure that benefits from the use of mobile charging stations 106 while still enabling the implementation of fixed charging stations 110 within the system.

Consider further the provisioning of vehicles that are associated with ride-sharing corporations such as Uber, Lyft, GRAB, to name a few, with mobile stations 402. Such ride-sharing corporations or organizations could obtain memberships with the consortium and operate as a network of mobile charging stations 106 whereby the ride-sharing corporation or organization would then be enabled to provide EV charging on demand in addition to their primary mission of providing “taxi” service. The vehicles working for the ride-sharing corporations could provide the charging by carrying either portable EVSE chargers on board their vehicle or using their service EV as chargers for charging another EV. The ride-sharing corporations in addition to providing the ride-sharing services they normally provide could also allow vehicles that provide charging functionalities to other vehicles or carry spare charging batteries or charging devices to enable reservations for charging an electric vehicle in addition to providing ride sharing services using the system described herein. Thus, an operator of a vehicle working for one of the ride-sharing services could be reserved for charging an electric vehicle or for providing a ride to a customer. This would double the potential revenue sources to the ride-sharing corporations.

It will be appreciated by those skilled in the art having the benefit of this disclosure that this system for a demand sensitive networked fleet of mobile power dispensing stations provides for implementing an electric vehicle charging infrastructure. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A system for networking a plurality of electric vehicle charging networks, comprising
a central charger controller for controlling access to a plurality of charging devices associated with the plurality of electric vehicle charging networks;
a plurality of control nodes each associated with one of the plurality of electric vehicle charging networks and enabling communication between the central charger controller and each of the plurality of electric vehicle charging networks;
a plurality of application program interfaces each associated with one of the plurality of control nodes enabling communication between a control node and one of the plurality of electric vehicle charging networks;
wherein the central charger controller monitors charging demand across each of the plurality of electric vehicle charging networks and dispatches mobile charging devices of the plurality of charging devices to locations responsive to the monitored load distribution.

2. The system of claim 1, wherein the central charger controller receives a request for charging from an electric vehicle associated with a first electric vehicle charging network of the plurality of electric vehicle charging networks and establishes a charging event for the first vehicle in a second electric vehicle charging network of the plurality of electric vehicle charging networks.

3. The system of claim 2, wherein the charging event comprises dispatching a mobile electric vehicle charging device to the first vehicle.

4. The system of claim 3, wherein central charger controller broadcast a request for bid from the plurality of electric vehicle charging networks responsive to the request for charging, receives a bid from the plurality of electric vehicle charging networks responsive to the request for bid, selects a winning bid and dispatches the mobile electric vehicle charging device of the winning bid to the first vehicle to the first vehicle.

5. The system of claim 1, wherein the central charger controller monitors driving activity of an electric vehicle in a first electric vehicle charging network of the plurality of electric vehicle charging networks, determines an upcoming charging need for the electric vehicle and dispatches a mobile electric vehicle charging station from a second electric vehicle charging network of the plurality of electric vehicle charging networks responsive to the determined charging need.

6. The system of claim 1, wherein the central charger controller manages membership of a requesting electric vehicle charging network with respect to the plurality of electric vehicle charging networks.

7. The system of claim 1 further comprising an artificial intelligence system for controlling the operation of the central charger controller.

8. The system of claim 1 further comprising:
a plurality of mobile electric charging stations with at least one charging device;
a transport platform for transporting the plurality of mobile electric charging devices; and
wherein the central charger controller dispatches the transport platform including the plurality of mobile electric charging devices to a predetermined location responsive to the monitored charging demand distribution.

9. The system of claim 1, wherein the plurality of charging devices comprises both mobile electric vehicle charging devices and fixed electric vehicle charging devices.

10. A system for networking a plurality of electric vehicle charging networks, comprising
a central charger controller for controlling access to a plurality of charging devices associated with the plurality of electric vehicle charging networks;
a plurality of control nodes each associated with one of the plurality of electric vehicle charging networks and enabling communication between the central charger controller and each of the plurality of electric vehicle charging networks, wherein at least a portion of the plurality of electric vehicle charging networks include ride-sharing providers that provide both charging services and ride sharing services;
a plurality of application program interfaces each associated with one of the plurality of control nodes enabling communication between a control node and one of the plurality of electric vehicle charging networks;
wherein the central charger controller receives a request for charging from an electric vehicle associated with a first electric vehicle charging network of the plurality of electric vehicle charging networks and establishes a charging event for the first vehicle in a second electric vehicle charging network of the plurality of electric vehicle charging networks.

11. The system of claim 10, wherein the charging event comprises dispatching a mobile electric vehicle charging device to the first vehicle.

12. The system of claim 10, wherein the central charger controller monitors driving activity of an electric vehicle in a first electric vehicle charging network of the plurality of electric vehicle charging networks, determines an upcoming charging need for the electric vehicle and dispatches a mobile electric vehicle charging device from a second electric vehicle charging network of the plurality of electric vehicle charging networks responsive to the determined charging need.

13. The system of claim 12, wherein central charger controller broadcast a request for bid from the plurality of electric vehicle charging networks responsive to the request for charging, receives a bid from the plurality of electric vehicle charging networks responsive to the request for bid, selects a winning bid and dispatches the mobile electric vehicle charging device of the winning bid to the first vehicle to the first vehicle.

14. The system of claim 10, wherein the central charger controller manages membership of a requesting electric vehicle charging network with respect to the plurality of electric vehicle charging networks.

15. The system of claim 10 further comprising an artificial intelligence system for controlling the operation of the central charger controller.

16. The system of claim 10, wherein the plurality of charging devices comprises both mobile electric vehicle charging devices and fixed electric vehicle charging devices.

17. A system for networking a plurality of electric vehicle charging networks, comprising
a central charger controller for controlling access to a plurality of charging devices associated with the plurality of electric vehicle charging networks; and
wherein the central charger controller receives a request for charging from an electric vehicle associated with a first electric vehicle charging network of the plurality of electric vehicle charging networks and establishes a charging event for the first vehicle in a second electric vehicle charging network of the plurality of electric vehicle charging networks.

18. The system of claim 17, wherein the central charger controller monitors charging demand distribution across each of the plurality of electric vehicle charging networks and dispatches mobile charging devices of the plurality of charging devices to locations responsive to the monitored load distribution.

19. The system of claim 17, wherein the charging event comprises dispatching a mobile electric vehicle charging device to the first vehicle.

20. The system of claim 17, wherein the central charger controller monitors driving activity of an electric vehicle in a first electric vehicle charging network of the plurality of electric vehicle charging networks, determines an upcoming charging need for the electric vehicle and dispatches a mobile electric vehicle charging device from a second electric vehicle charging network of the plurality of electric vehicle charging networks responsive to the determined charging need.

21. The system of claim 17 further comprising an artificial intelligence system for controlling the operation of the central charger controller.

22. The system of claim 17, wherein the plurality of charging devices comprises both mobile electric vehicle charging devices and fixed electric vehicle charging devices.
